(19) United States
(12) Patent Application Publication
(10) Pub. No.: US 2005/0199663 A1
(43) Pub. Date: Sep. 15, 2005

(54) Safety system for a portable data collection device

(75) Inventors: Michael A. Heaton, Owego, NY (US); Shane F. Mills, Owego, NY (US)

Correspondence Address: TAROLLI, SUNDHEIM, COVELL & TUMMINO LLP, Suite 1111, 526 Superior Avenue, Cleveland, OH, 44114, US

(73) Assignee: Lockheed Martin Corporation

(21) Appl. No.: 11/052,965

(22) Filed: Feb. 8, 2005

Related U.S. Application Data
(60) Provisional application No. 60/550,647, filed on Mar. 5, 2004.

(51) Int. Cl. A62B 9/04

(52) U.S. Cl. 224/269

(57) ABSTRACT

A system provides safety for a portable data collection device. The system includes a holster for the portable data collection device, a belt clip attachable to a person, and an automatically detachable safety interface device interconnecting the holster and the belt clip. The detachable safety interface device is appropriately sized and designed to detach upon the application of a predetermined force acting on the automatically detachable safety interface device from any direction.

### REFERENCE TO A PRIOR APPLICATION

This application claims the benefit of U.S. Provisional Application No. 60/550,647, filed Mar. 5, 2004.

### FIELD OF INVENTION

The present invention is directed to an electronic data collection system and, more particularly, to a safety system for a portable electronic data collection device.

### BACKGROUND OF THE INVENTION

A conventional data collection system includes a hand-held unit operating from battery power and functioning to collect and process data by a sequence of automated and/or manual operations. A typical automated process is the non-contact scanning of bar code data by means of a cyclically deflected laser beam or an image photosensor. Once a valid bar code reading has been obtained, a keypad may be manually operated to indicate an associated quantity. The user may then manually initiate a further operation, for example, the on-line transmission of the data to a remote host computer by a known means such as a radio frequency communications link.

It would be desirable to have a basic data collection system, which is lightweight and compact, and which would not endanger a user if part of the system became entangled in machinery.

### SUMMARY OF THE INVENTION

In accordance with one feature of the present invention, a system provides safety for a portable data collection device. The system includes a holster for the portable data collection device, a belt clip attachable to a person, and an automatically detachable safety interface device interconnecting the holster and the belt clip. The detachable safety interface device is appropriately sized and designed to detach upon the application of a predetermined force acting on the automatically detachable safety interface device from any direction.

In accordance with another feature of the present invention, the detachable safety interface device may include a magnetic fastener interconnecting the holster and the belt clip.

In accordance with another feature of the present invention, the detachable safety interface device may include a plastic buckle fastener interconnecting the holster and the belt clip.

In accordance with still another feature of the present invention, the detachable safety interface device may include a hook and loop fastener arrangement with a first hook portion permanently attached to the holster and a second loop portion permanently attached to the belt clip.

In accordance with yet another feature of the present invention, the detachable safety interface device may include a first stitched interface portion and a second stitched interface portion designed to detach from the first stitched interface portion upon the application of a predetermined force acting on the automatically detachable safety interface device from any direction.

In accordance with still another feature of the present invention, the detachable safety interface device may include a belt detachable from the holster, the belt being appropriately sized and designed to detach from the holster upon the application of a predetermined force acting on the automatically detachable safety interface device from any direction.

In accordance with yet another feature of the present invention, the detachable safety interface device may include a first snap portion and a second snap portion designed to detach from the first snap portion upon the application of a predetermined force acting on the automatically detachable safety interface device from any direction.

### BRIEF DESCRIPTION OF THE DRAWINGS

The foregoing and other features of the present invention will become apparent to one skilled in the art to which the present invention relates upon consideration of the following description of the invention with reference to the accompanying drawings, wherein:

FIG. 1 is a schematic representation of part of a system in accordance with the present invention;

FIG. 2 is a schematic representation of part of a system in accordance with one feature of the present invention;

FIG. 3 is a schematic representation of part of a system in accordance with another feature of the present invention;

FIG. 4 is a schematic representation of part of a system in accordance with still another feature of the present invention;

FIG. 5 is a schematic representation of part of a system in accordance with yet another feature of the present invention; and

FIG. 6 is a schematic representation of part of a system in accordance with still another feature of the present invention.

### DESCRIPTION OF EXAMPLE EMBODIMENTS

Industrial safety is of the utmost importance in the current working environment, particularly the United States Postal Service. Injuries and worker's compensation claims must be kept to a minimum. In order to minimize worker's compensation claims and injuries, special attention should be paid to man-machine interfaces, where injuries often occur. Such an interface is the “permanent” attachment of equipment to a worker's, or mail carrier's, belt, pocket, jacket, etc. If this equipment becomes entangled in a machine, such as an industrial mail sortation machine, this equipment could pull the person into the machine causing great injury.

A system in accordance with the present invention provides an automatically detachable holstering device for portable data terminals and other equipment, thereby minimizing injuries. The system may allow the automatic detachment of the holstering device/data terminal under loading conditions (tension/compression/angular) from any direction.

The system provides a holstering device for automatically (unintentionally) separating from an operator in a hazardous environment. The system may include different means for the same, safe end result (i.e., detachment of a holster from a person without causing injury, etc.).

The system 10 may include a holster 20 for a portable data terminal (PDT), a belt 30 of a worker, a belt clip 40 for attaching the holster to the belt, an automatically detachable safety interface 150, 250, 350, 450 or 550.

The holster 20 is generally rectangular in shape (FIG. 1) and has a first side 22, a second side 24 opposite the first side, a third side 26 adjacent the first side, and a fourth side 28 opposite the third side and adjacent the first side. The holster 20 also has a flap 29 for attaching the holster 20 to a worker. The holster 20 may be sized to fit an appropriate data collection device snugly when the holster is hanging from the belt 30 of a worker.

The detachable safety interface device 150, 250, 350, 450 or 550 is appropriately sized and designed to detach upon the application of a predetermined force acting on the automatically detachable safety interface device from any direction.

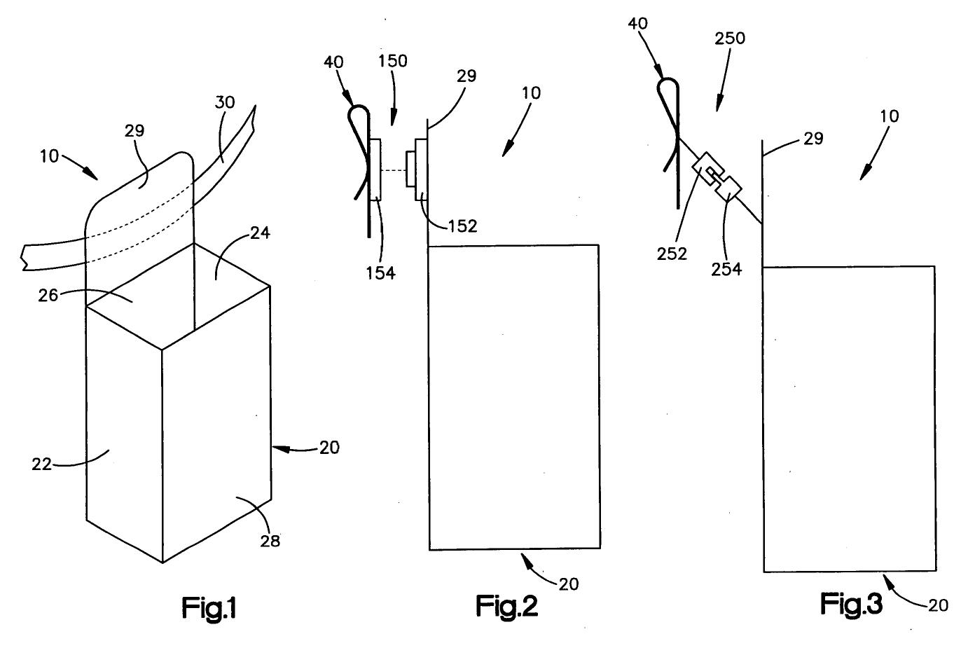

In accordance with one feature of the present invention (FIG. 2), the system 10 may include a portable data terminal (PDT) holster 20, a belt clip 40 attachable to the belt 30 of a person, and an automatically detachable safety interface device 150 interconnecting the holster 20 and the belt clip 40. The detachable safety interface device 150 is reliable, repeatable, and rugged.

The detachable safety interface device 150 may include a magnetic fastener, or “button” magnet, interconnecting the holster 20 and the belt clip 40. The magnetic fastener includes a non-magnetic male portion 152 and magnetic female portion 154. The male portion 152 may be sewn, riveted, or crimped to the flap 29 of the holster 20. The female portion 154 may be sewn, riveted, or crimped to the belt clip 40. A magnet of the female portion 154 may be appropriately sized and designed to provide a breakaway force appropriate for worker safety. The force acting on the automatically detachable safety interface device 150 may be applied from any direction and still provide breakaway.

The breakaway force may be, for example, from 10 to 50 lbs, but could be an amount appropriate for any application. Factors such as the mode of force, impact force vs. linear force, force vectors, and compound loading may be considered for a breakaway force calculation. Alternatively, empirical tests may be conducted for determining an appropriate breakaway force.

Upon assembly of the magnetic fastener, no magnetic flux interferes with portable data terminal circuitry. The magnetic female portion 154 of the magnetic fastener is attached to the belt clip 40 to protect the circuitry of the portable data terminal when the portable data terminal is unholstered and to discourage placing the holster 20 on anything metallic for storage purposes.

Typically, the magnetism separation strength and amount of holster movement may be determined to match the desired interface travel before a breakaway force is applied and the desired axis for separating the holster (20) from the belt clip (40). Forces (i.e., x, y, z, phi, and theta directions caused by the belt clip (40) being pulled away from the holster (20) or the holster being pulled from the belt clip) acting upon an axis may determine a magnetic separation strength of a material used in magnetic clasp components. By mounting a magnetic clasp between the holster (20) material and the belt clip (40) material (e.g. nylon, polyester, cordura, etc.), the amount of compliancy before resistance may be determined by the type of material used to manufacture the portable data collection device holster (20).

The magnet design may be integrated with the overall design of the holster (20) and belt clip (40). Other factors affecting the magnet design may be the magnitude of magnetic properties to achieve the overall system design, a magnetizing orientation (e.g. axial, axial/multi-poles/axial/parallel/multi-poles, radial, diametric, lateral/parallel/multi-poles on one side only), reusability of the system subsequent to an initial separation, method of fastening the magnet to the material (e.g. glue, fasteners, thread, rivet, etc), and, if desired, an orientation feature in the physical shape of the interface device to properly align two magnetic components for optimum magnetic performance.

In accordance with one feature of the present invention (FIG. 3), the system 10 may include a portable data terminal (PDT) holster 20, a belt clip 40 attachable to the belt 30 of a person, and an automatically detachable safety interface device 250 interconnecting the holster 20 and the belt clip 40. The detachable safety interface device 250 is reliable, repeatable, and rugged.

The detachable safety interface device 250 may include a plastic buckle fastener interconnecting the holster 20 and the belt clip 40. The plastic buckle fastener includes a female portion 252 sewn to the belt clip 40 and a male portion 254 sewn to the flap 29 of the holster 20 (or vice versa). The plastic buckle fastener provides the holster 20 with some freedom of movement, ideally enough freedom of movement to allow pliancy before separation of the female portion 252 from the male portion 254 should the holster become entangled with a hazard.

This small amount of pliancy provides for few nuisance separations. A separation force may be, for example, from 10 to 50 lbs, but could be an amount appropriate for any application. Factors such as the mode of force, impact force vs. linear force, force vectors, and compound loading may be considered for a breakaway force calculation. Alternatively, empirical tests may be conducted for determining an appropriate breakaway force.

Typically, the buckle separation strength and amount of holster movement may be determined to match the desired interface travel before a breakaway force is applied and the desired axis for separating the holster (20) from the belt clip (40). Forces (i.e., x, y, z, phi, and theta directions caused by the belt clip (40) being pulled away from the holster (20) or the holster being pulled from the belt clip) acting upon the axis where separation between the belt clip (40) and holster (20) occurs may determine buckle separation strength of the material used for the buckle components. The mounting of the buckle (40) to the holster (20) and belt clip (40) material (e.g. nylon, polyester, cordura, etc.) and the amount of compliancy before the force encounters resistance may be determined by the type of material used to create the portable data collection device holster.

The buckle design may be integrated with the overall design of the holster (20) and belt clip (40). Other factors affecting buckle design may be resistance to a predetermined force before separation occurs, reusability of the system subsequent to an initial separation, method of fastening the buckle to the material (e.g. glue, fasteners, thread, stitching, etc), and, if desired, an orientation feature in the physical shape of the buckle components to properly align the buckle components for optimum buckle performance.

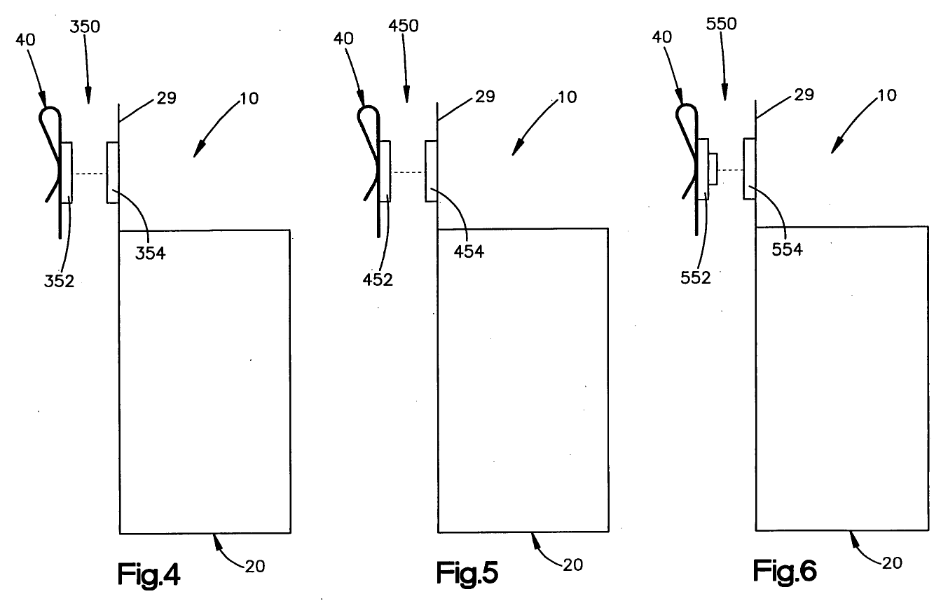

In accordance with still another feature of the present invention (FIG. 4), the system 10 may include a portable data terminal (PDT) holster 20, a belt clip 40 attachable to the belt 30 of a person, and an automatically detachable safety interface device 350 interconnecting the holster 20 and the belt clip 40. The detachable safety interface device 350 is reliable, repeatable, and rugged.

The detachable safety interface device 350 may include hook and loop (i.e., VELCRO, etc.) interface with one panel 352 connected to the belt clip 40 and one panel 354 connected to the flap 29 of the holster 20. When a force is applied on the detachable safety interface device 350 from any direction, the panels 352, 354 may peel off from each other accordingly.

Typically, the Velcro hook and loop separation strength and amount of holster movement may be determined to match a desired interface travel before a breakaway force and desired axis for separating the holster (20) from the belt clip (40). Forces (i.e., x, y, z, phi, and theta directions caused by the belt clip (40) being pulled away from the holster (20) or the holster being pulled from the belt clip) acting upon the axis where the separation between the belt clip (40) and holster (20) occurs may determine Velcro separation strength. By mounting the hook and loop to the holster (20) and belt clip (40) material (e.g. nylon, polyester, cordura, etc.), the amount of compliancy before encountering resistance may be determined by the type of material.

The hook and loop design may be integrated with the overall design of the belt clip (40) and holster (20). Other factors affecting the hook and loop design may be surface area of the hooks, surface area of the loops, method of fastening the buckle to the material (e.g. glue, fasteners, thread, etc), and, if desired, an orientation feature in the physical shape to properly align the Velcro components for optimum buckle performance.

In accordance with yet another feature of the present invention (FIG. 5), the system 10 may include a portable data terminal (PDT) holster 20, a belt clip 40 attachable to the belt 30 of a person, and an automatically detachable safety interface device 450 interconnecting the holster 20 and the belt clip 40. The detachable safety interface device 450 is reliable, repeatable, and rugged.

The detachable safety interface device 450 may include a stitched interface point 452 attached to the belt clip 40 and a stitched interface point 454 attached to the flap 29 of the holster 20. The stitched interface points 452, 454 may be designed for ripping upon the application of a minimum predetermined force from any direction.

Typically, the holster may have a sewn stitch breakaway interface. The stitch pattern, thread tensile strength, holster (20) and belt clip (40) material strength, and amount of holster movement may determine desired interface travel before a breakaway force and desired axis for separating the holster (20) from the belt clip (40). Forces (i.e., x, y, z, phi, and theta directions caused by the belt clip (40) being pulled away from the holster (20) or the holster being pulled from the belt clip) acting upon the axis where the separation between the belt clip (40) and holster (20) occurs may determine stitch separation strength of the material. By using thread and sewing the two fabric materials together, the holster (20) and belt clip (40) material (e.g. nylon, polyester, cordura, etc.) may determine the amount of compliancy before encountering resistance.

The stitch design may be integrated with the overall design. Another factor affecting thread design may be a predefined pattern with a predefined tensile strength that yields a separation between the holster (20) and belt clip (40).

In accordance with still another feature of the present invention (FIG. 6), the system 10 may include a portable data terminal (PDT) holster 20, a belt clip 40 attachable to the belt 30 of a person, and an automatically detachable safety interface device 550 interconnecting the holster 20 and the belt clip 40. The detachable safety interface device 550 is reliable, repeatable, and rugged.

The detachable safety interface device 550 may include a snap or snaps having a female portion 554 attached to the flap 29 of the holster 20 and a male portion 554 attached to the belt clip 40 (or vice versa). The female and male portions 552, 554 may be designed for disengaging from each other upon the application of a minimum predetermined force from any direction.

Typically, the snap separation strength and amount of holster movement may be determined to match the desired interface travel before a breakaway force and desired axis for separating the holster (20) from the belt clip (40). Forces (i.e., x, y, z, phi, and theta directions caused by the belt clip (40) being pulled away from the holster (20) or the holster being pulled from the belt clip) acting upon the axis where separation between the belt clip (40) and holster (20) occurs may determine the snap separation strength of the design and material used in the snap components. By mounting a male and female snap to the holster (20) and belt clip (40) material (e.g. nylon, polyester, cordura, etc.), the amount of compliancy before encountering resistance may be determined.

A snap design may be integrated with the overall design. Other factors affecting the snap design may be resistance to a predetermined force before separation occurs, reusability subsequent to initial separation, method of fastening the buckle to the material (e.g. glue, fasteners, thread, etc), and, if desired, an orientation feature in the physical shape to properly align the snap components for optimum buckle performance.

Also, the belt 30 itself may be designed to break away from the worker (or the holster 20) while remaining attached to the flap 29 of the holster 20 (or the worker). The belt 30 may detach from the worker upon the application of a minimum predetermined force from any direction.

The presently disclosed embodiments are considered in all respects to be illustrative, and not restrictive. For example, the location of male and female parts in several of the embodiments may be interchanged. The scope of the invention is indicated by the appended claims, rather than the foregoing description, and all changes that come within the meaning and range of equivalence thereof are intended to be embraced therein.

1. A safety system for a portable data collection device, said safety system comprising:
a holster for the portable data collection device;
a belt clip attachable to a person; and
an automatically detachable safety interface device interconnecting said holster and said belt clip, said detachable safety interface device being appropriately sized and designed to detach upon the application of a predetermined force acting on said automatically detachable safety interface device from any direction.

2. The safety system as set forth in claim 1 wherein said detachable safety interface device includes a magnetic fastener interconnecting said holster and said belt clip.

3. The safety system as set forth in claim 2 wherein said magnetic fastener includes a non-magnetic male portion and magnetic female portion.

4. The safety system as set forth in claim 3 wherein said male portion is permanently attached to said holster and said female portion is permanently attached to said belt clip, a magnet of said female portion being appropriately sized and designed to detach from said male portion upon the application of a predetermined force acting on said automatically detachable safety interface device from any direction.

5. The safety system as set forth in claim 1 wherein said detachable safety interface device includes a plastic buckle fastener interconnecting said holster and said belt clip.

6. The safety system as set forth in claim 5 wherein said plastic buckle fastener includes a female portion permanently attached to said belt clip and a male portion permanently attached to said holster

7. The safety system as set forth in claim 6 wherein said female portion of said plastic buckle fastener is appropriately sized and designed to detach from said male portion upon the application of a predetermined force acting on said automatically detachable safety interface device from any direction.

8. The safety system as set forth in claim 1 wherein said detachable safety interface device includes a hook and loop fastener arrangement with a first hook portion permanently attached to said holster and a second loop portion permanently attached to said belt clip.

9. The safety system as set forth in claim 8 wherein said first hook portion of said arrangement is appropriately sized and designed to detach from said second loop portion upon the application of a predetermined force acting on said automatically detachable safety interface device from any direction.

10. The safety system as set forth in claim 1 wherein said detachable safety interface device includes a first stitched interface portion and a second stitched interface portion.

11. The safety system as set forth in claim 10 wherein said first stitched interface portion is appropriately sized and designed to detach from said second stitched interface portion upon the application of a predetermined force acting on said automatically detachable safety interface device from any direction.

12. The safety system as set forth in claim 1 wherein said detachable safety interface device includes a belt detachable from said holster, said belt being appropriately sized and designed to detach from said holster upon the application of a predetermined force acting on said automatically detachable safety interface device from any direction.

13. The safety system as set forth in claim 1 wherein said detachable safety interface device includes a first snap portion and a second snap portion.

14. The safety system as set forth in claim 13 wherein said first snap portion is appropriately sized and designed to detach from said second snap portion upon the application of a predetermined force acting on said automatically detachable safety interface device from any direction.
